(19) United States
(12) Patent Application Publication
(10) Pub. No.: US 2026/0046071 A1
(43) Pub. Date: Feb. 12, 2026

(54) CONDITIONS FOR AUTONOMOUS RETRANSMISSIONS IN RADIO LINK CONTROL

(71) Applicant: Lenovo (Singapore) Pte. Limited, Singapore (SG)

(72) Inventors: Shwetha Sreejith, Steinbach (DE); Joachim Löhr, Wiesbaden (DE)

(73) Assignee: Lenovo (Singapore) Pte. Limited, Singapore (SG)

(21) Appl. No.: 18/797,351

(22) Filed: Aug. 7, 2024

(51) Int. Cl. H04L 1/1812; H04L 1/1867

(52) U.S. Cl. CPC H04L 1/1816; H04L 1/188

(57) ABSTRACT

Various aspects of the present disclosure relate to conditions for autonomous retransmissions in radio link control. An apparatus (e.g., user equipment (UE)), receives a first configuration associated with a radio link control (RLC) entity, where autonomous retransmission for the RLC entity is enabled or disabled according to the first configuration and based at least in part on one or more conditions, and receives a second configuration associated with the RLC entity, where the second configuration indicates a timer associated with the autonomous retransmission for the RLC entity. The UE autonomously retransmits a first subset of RLC protocol data units (PDUs) based at least in part on the one or more conditions, starts the timer in accordance with the second configuration and in response to the autonomously retransmitted first subset of RLC PDUs, and prohibits a subsequent autonomous retransmission for the RLC entity until expiry of the timer.

### TECHNICAL FIELD

The present disclosure relates to wireless communications, and more specifically to controlling data retransmissions in wireless communications.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations (e.g., gNBs), network entities, satellites, and/or network equipment (NE), among other devices, that transmit and/or receive signaling.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may include a UE for wireless communication to receive a first configuration associated with a radio link control (RLC) entity of the UE, wherein autonomous retransmission for the RLC entity of the UE is enabled or disabled according to the first configuration and based at least in part on one or more conditions; receive a second configuration associated with the RLC entity of the UE, wherein the second configuration indicates a timer associated with the autonomous retransmission for the RLC entity; autonomously retransmit a first subset of one or more RLC protocol data units (PDUs) based at least in part on the one or more conditions; start the timer in accordance with the second configuration and in response to the autonomously retransmitted first subset of one or more RLC PDUs; and prohibit a subsequent autonomous retransmission for the RLC entity until expiry of the timer.

In some implementations of the method and apparatuses for a UE described herein, the second configuration further indicates a threshold number of autonomous retransmissions, the one or more conditions include the threshold number of autonomous retransmissions, and the first subset of one or more RLC PDUs is autonomously retransmitted based at least in part on the threshold number of autonomous retransmissions; the first configuration includes a parameter for enabling or disabling the autonomous retransmission for the RLC entity; the first configuration including the parameter for enabling or disabling the autonomous retransmission for the RLC entity is received via a radio resource control (RRC) message; the at least one processor is further configured to cause the UE to determine that the autonomous retransmission for the RLC entity of the UE is disabled based at least in part on an absence of a parameter in the received first configuration; the at least one processor is configured to cause the UE to: identify a network congestion level based at least in part on an indication, or identify that PDU set importance (PSI) discarding is enabled, or both, wherein at least one condition of the one or more conditions includes the identified network congestion level, or the identified discarding for the RLC entity of the UE being enabled, wherein the subsequent autonomous retransmission for the RLC entity is prohibited based at least in part on the identified network congestion level, or the identified discarding for the RLC entity of the UE being enabled.

In some implementations of the method and apparatuses for a UE described herein, the at least one processor is configured to cause the UE to: identify that the autonomous retransmission for the RLC entity of the UE is applicable for RLC PDUs associated with a priority, wherein at least one condition of the one or more conditions includes the priority, wherein the first subset of one or more RLC PDUs is autonomously retransmitted based at least in part on a corresponding priority associated with each RLC PDU of the first subset of one or more RLC PDUs satisfying the priority; the at least one processor is configured to cause the UE to: identify that the autonomous retransmission for the RLC entity of the UE is applicable for RLC PDUs associated with a corresponding PSI value, wherein the corresponding PSI value is greater than a PSI threshold value, wherein the first subset of one or more RLC PDUs is autonomously retransmitted based at least in part on a respective PSI value of each RLC PDU of the first subset of one or more RLC PDUs satisfying the PSI threshold value; the at least one processor is configured to cause the UE to: receive an acknowledgement (ACK) for a second subset of one or more RLC PDUs; and discard the second subset of one or more RLC PDUs based at least in part on the received ACK, wherein the second subset of one or more RLC PDUs comprises of one or more RLC PDUs for which autonomous retransmission has been triggered prior to reception of the ACK; the at least one processor is configured to cause the UE to prioritize the first subset of one or more RLC PDUs for the autonomous retransmission over a second subset of one or more RLC PDUs pending a non-autonomous retransmission and one or more initial RLC PDU transmissions.

In some implementations of the method and apparatuses for a UE described herein, the at least one processor is configured to cause the UE to prioritize allocation of uplink resources for one or more logical channels carrying one or more autonomously retransmitted RLC PDUs over allocation of uplink resources for one or more logical channels carrying non-autonomously retransmitted RLC PDUs; the at least one processor is configured to cause the UE to prioritize a hybrid automatic repeat request (HARQ) process associated with one or more autonomously retransmitted RLC PDUs over one or more other HARQ processes; the at least one processor is configured to cause the UE to: communicate information identifying the one or more first RLC PDUs that are autonomously retransmitted; receive an indication of a HARQ ACK for a transport block (TB) associated with the one or more first RLC PDUs; and prohibit, based at least in part on the HARQ ACK, triggering an additional autonomous retransmission of the one or more first RLC PDUs; the at least one processor is configured to cause the UE to: receive, via inter-layer communication, an indication of a HARQ ACK for the one or more first RLC PDUs; and prohibit, based at least in part on the HARQ ACK, triggering an autonomous retransmission of the one or more first RLC PDUs.

Some implementations of the method and apparatuses described herein may further include a processor for wireless communication to receive a first configuration associated with a RLC entity of a UE, wherein autonomous retransmission for the RLC entity of the UE is enabled or disabled according to the first configuration and based at least in part on one or more conditions; receive a second configuration associated with the RLC entity of the UE, wherein the second configuration indicates a timer associated with the autonomous retransmission for the RLC entity; autonomously retransmit a first subset of one or more RLC PDUs based at least in part on the one or more conditions; start the timer in accordance with the second configuration and in response to the autonomously retransmitted first subset of one or more RLC PDUs; and prohibit a subsequent autonomous retransmission for the RLC entity until expiry of the timer.

Some implementations of the method and apparatuses described herein may further include a method performed by a UE, the method including receiving a first configuration associated with a RLC entity of the UE, wherein autonomous retransmission for the RLC entity of the UE is enabled or disabled according to the first configuration and based at least in part on one or more conditions; receiving a second configuration associated with the RLC entity of the UE, wherein the second configuration indicates a timer associated with the autonomous retransmission for the RLC entity; autonomously retransmitting a first subset of one or more RLC PDUs based at least in part on the one or more conditions; starting the timer in accordance with the second configuration and in response to the autonomously retransmitted first subset of one or more RLC PDUs; and prohibiting a subsequent autonomous retransmission for the RLC entity until expiry of the timer.

In some implementations of the method and apparatuses for a UE described herein, the second configuration further indicates a threshold number of autonomous retransmissions, the one or more conditions include the threshold number of autonomous retransmissions, and the first subset of one or more RLC PDUs is autonomously retransmitted based at least in part on the threshold number of autonomous retransmissions; the first configuration includes a parameter for enabling or disabling the autonomous retransmission for the RLC entity; the first configuration including the parameter for enabling or disabling the autonomous retransmission for the RLC entity is received via a RRC message; further including determining that the autonomous retransmission for the RLC entity of the UE is disabled based at least in part on an absence of a parameter in the received first configuration; further including: identifying a network congestion level based at least in part on an indication, or identify that PSI discarding is enabled, or both, wherein at least one condition of the one or more conditions includes the identified network congestion level, or the identified discarding for the RLC entity of the UE being enabled, wherein the subsequent autonomous retransmission for the RLC entity is prohibited based at least in part on the identified network congestion level, or the identified discarding for the RLC entity of the UE being enabled.

In some implementations of the method and apparatuses for a UE described herein, further including: identifying that the autonomous retransmission for the RLC entity of the UE is applicable for RLC PDUs associated with a priority, wherein at least one condition of the one or more conditions includes the priority, wherein the first subset of one or more RLC PDUs is autonomously retransmitted based at least in part on a corresponding priority associated with each RLC PDU of the first subset of one or more RLC PDUs satisfying the priority; further including: identifying that the autonomous retransmission for the RLC entity of the UE is applicable for RLC PDUs associated with a corresponding PSI value, wherein the corresponding PSI value is greater than a PSI threshold value, wherein the first subset of one or more RLC PDUs is autonomously retransmitted based at least in part on a respective PSI value of each RLC PDU of the first subset of one or more RLC PDUs satisfying the PSI threshold value; further including: triggering the subsequent autonomous retransmission for the RLC entity of the UE, wherein the subsequent autonomous retransmission includes a second subset of one or more RLC PDUs; receiving an ACK for the second subset of one or more RLC PDUs; and discarding the second subset of one or more RLC PDUs based at least in part on the received ACK, wherein the second subset of one or more RLC PDUs comprises of one or more RLC PDUs for which autonomous retransmission has been triggered prior to reception of the ACK.

In some implementations of the method and apparatuses for a UE described herein, further including prioritizing the first subset of one or more RLC PDUs for the autonomous retransmission over a second subset of one or more RLC PDUs pending a non-autonomous retransmission and one or more initial RLC PDU transmissions; further including prioritizing allocation of uplink resources for one or more logical channels carrying one or more autonomously retransmitted RLC PDUs over allocation of uplink resources for one or more logical channels carrying non-autonomously retransmitted RLC PDUs; further including prioritizing a HARQ process associated with one or more autonomously retransmitted RLC PDUs over one or more other HARQ processes; further including: communicating information identifying the one or more first RLC PDUs that are autonomously retransmitted; receiving an indication of a HARQ ACK for a TB associated with the one or more first RLC PDUs; and prohibiting, based at least in part on the HARQ ACK, triggering an additional autonomous retransmission of the one or more first RLC PDUs; further including: receiving, via inter-layer communication, an indication of a HARQ ACK for the one or more first RLC PDUs; and prohibiting, based at least in part on the HARQ ACK, triggering an autonomous retransmission of the one or more first RLC PDUs.

Some implementations of the method and apparatuses described herein may further include a NE for wireless communication to transmit a first configuration associated with a RLC entity of a UE to enable or disable autonomous retransmission for the RLC entity of the UE according to the first configuration and based at least in part on one or more conditions; and transmit a second configuration associated with the RLC entity of the UE, wherein the second configuration indicates a timer associated with the autonomous retransmission for the RLC entity.

In some implementations of the method and apparatuses for a NE described herein, the first configuration includes a parameter configured to enable or disable autonomous retransmission functionality of the RLC entity; the one or more conditions include one or more of an indication of network congestion or an indication that PSI discarding is enabled; the at least one processor is configured to cause the network equipment to transmit an indication of one or more conditions for performing autonomous retransmission, and wherein the one or more conditions indicate at least one of: autonomous retransmission is constrained to one or more RLC PDUs that are indicated as high-importance RLC PDUs; or autonomous retransmission is constrained to one or more RLC PDUs that have a PSI value greater than a PSI threshold.

Some implementations of the method and apparatuses described herein may further include a method performed by a NE, the method including transmitting a first configuration associated with a RLC entity of a UE to enable or disable autonomous retransmission for the RLC entity of the UE according to the first configuration and based at least in part on one or more conditions; and transmitting a second configuration associated with the RLC entity of the UE, wherein the second configuration indicates a timer associated with the autonomous retransmission for the RLC entity.

In some implementations of the method and apparatuses described herein, the first configuration includes a parameter configured to enable or disable autonomous retransmission functionality of the RLC entity; the one or more conditions include one or more of an indication of network congestion or an indication that PSI discarding is enabled; further including transmitting an indication of one or more conditions for performing autonomous retransmission, and wherein the one or more conditions indicate at least one of: autonomous retransmission is constrained to one or more RLC PDUs that are indicated as high-importance RLC PDUs; or autonomous retransmission is constrained to one or more RLC PDUs that have a PSI value greater than a PSI threshold.

### BRIEF DESCRIPTION OF THE DRAWINGS

FIG. 1 illustrates an example of a wireless communications system in accordance with aspects of the present disclosure.

FIG. 2 illustrates a scenario for PDCP and RLC reception.

FIG. 3 illustrates a scenario for PDCP and RLC Reception after t-Reordering expiry.

FIGS. 4-7 illustrate an example information element in accordance with aspects of the present disclosure.

FIGS. 8-11 illustrate an example information element in accordance with aspects of the present disclosure.

FIG. 12 illustrates an example of a UE in accordance with aspects of the present disclosure.

FIG. 13 illustrates an example of a processor in accordance with aspects of the present disclosure.

FIG. 14 illustrates an example of a NE in accordance with aspects of the present disclosure.

FIG. 15 illustrates a flowchart of a method in accordance with aspects of the present disclosure.

FIG. 16 illustrates a flowchart of a method in accordance with aspects of the present disclosure.

### DETAILED DESCRIPTION

In a wireless communications system, a UE and a NE (e.g., a base station, gNB) may support wireless communication (e.g., reception and/or transmission of wireless communication) using time-frequency resources. Further, wireless communication such as between a UE and NE can involve data transmission and retransmission. A data retransmission can occur, for instance, in cases where an initial data transmission encounters an error condition. Autonomous retransmissions refer to data retransmissions that are triggered at the RLC transmitter without the transmitter receiving a status report (e.g., indicating a negative acknowledgement (NACK)) from its peer entity. One issue with autonomous retransmissions is that they may quickly congest the link if the RLC transmits too many unnecessary autonomously retransmitted packets. This may further aggravate the delay encountered in data transmission. Another problem faced with autonomous retransmissions is that they may be redundant if triggered too early, e.g., before an initial transmission was received by the peer entity and/or if a packet was already ACKed but the RLC has not yet received the ACK. This redundancy can lead to reduced throughput and resource wastage. Further, the medium access control (MAC) HARQ may also be simultaneously trying to recover and/or correctly decode a TB when an autonomous retransmission is triggered in RLC. If the MAC HARQ is successful in decoding a TB consisting of an RLC PDU that was also autonomously retransmitted, the autonomous retransmission can be redundant leading to resource wastage, reduced throughput, and increased latencies.

Aspects of the present disclosure are described in the context of a wireless communications system, and include implementations that provide conditions and/or triggers that may be used to restrict autonomous retransmissions to specific scenarios to maintain efficiency in terms of latency and resource utilization. Furthermore, this disclosure provides optimizations in RLC and MAC to prevent additional congestion on the user-plane due to autonomous retransmissions.

For instance, in implementations a RLC entity at a UE can be configured by the network with an autonomous retransmission function, which can provide the network with additional control over when autonomous retransmission may be used. For example, the use of autonomous retransmission may be constrained to data that is delay-critical or is indicated as high-importance, e.g., based on PSI values. Furthermore, autonomous retransmission may be disabled when the network determines congestion on the user-plane to avoid aggravating the congestion. This disclosure further discusses how autonomously retransmitted data can be prioritized to avoid further delays in the reception of such data.

In implementations, autonomous retransmissions in RLC may be configured for an RLC entity by RRC. For example, a configuration can specify that only a RLC entity configured with autonomous retransmission may retransmit RLC PDU(s) autonomously without waiting for a status report from its peer entity. In one implementation, this configuration may be introduced as a new parameter (e.g., autonomousRetx) within the RLC-Config Information Element in RRC.

Implementations also provide RLC Behavior after receiving a NACK. For instance, the RLC transmitter may maintain an additional timer (e.g., t-AutonomousRetxProhibit) as configured by RRC to prevent triggering multiple retransmissions. For example, when RLC has already triggered an autonomous retransmission of one or more RLC PDU(s) and a NACK is received for one or more of those PDU(s), a second retransmission of the same PDU(s) is not to be transmitted until the expiry of the t-AutonomousRetxProhibit. This timer can be started upon an autonomous retransmission of one or more RLC PDU(s).

Implementations also provide for RLC Behavior after receiving an ACK. For example, when RLC has already triggered an autonomous retransmission of one or more RLC PDU(s) and an ACK is received for one or more of the PDU(s), and the autonomously retransmitted PDU(s) have not yet been submitted to lower layers, the RLC transmitter may discard the PDU(s). Additionally, if the autonomously retransmitted PDU(s) were already submitted to lower layers, the RLC transmitter may inform the MAC entity of the PDU(s) that no longer need to be retransmitted (e.g., due to the reception of an ACK) by means of inter-layer communication. The MAC entity may further discard these packets if they had not yet been transmitted in a TB.

By performing the described techniques, a device in a wireless communications system can decrease signaling overhead and link congestion that may result from data retransmissions.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

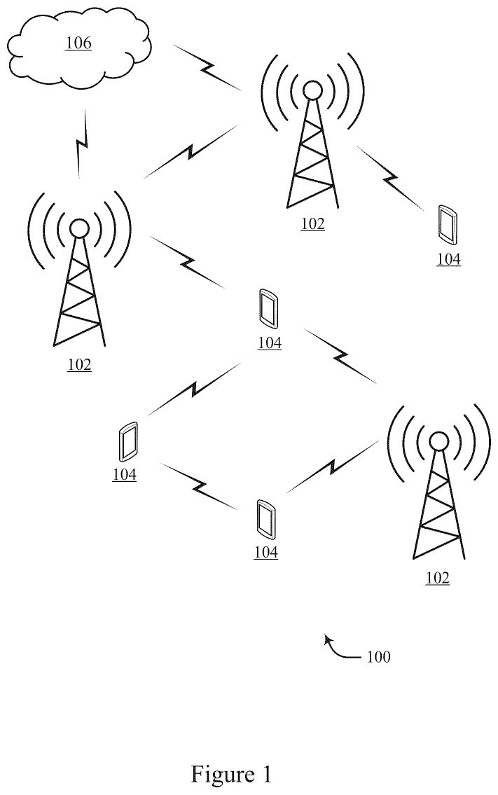

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (CNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (e.g., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., p=0) may be associated with a first subcarrier spacing (e.g., 15 kHz) and a normal cyclic prefix. In some implementations, the first numerology (e.g., p=0) associated with the first subcarrier spacing (e.g., 15 kHz) may utilize one slot per subframe. A second numerology (e.g., u=1) may be associated with a second subcarrier spacing (e.g., 30 kHz) and a normal cyclic prefix. A third numerology (e.g., u=2) may be associated with a third subcarrier spacing (e.g., 60 kHz) and a normal cyclic prefix or an extended cyclic prefix. A fourth numerology (e.g., u=3) may be associated with a fourth subcarrier spacing (e.g., 120 kHz) and a normal cyclic prefix. A fifth numerology (e.g., u=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (e.g., p=0, p=1, u=2, u=3, u=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., p=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHZ-52.6 GHZ), FR3 (7.125 GHZ-24.25 GHZ), FR4 (52.6 GHz-114.25 GHZ), FR4a or FR4-1 (52.6 GHZ-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., u=0), which includes 15 kHz subcarrier spacing; a second numerology (e.g., u=1), which includes 30 kHz subcarrier spacing; and a third numerology (e.g., u=2), which includes 60 kHz subcarrier spacing. FR2 may be associated with one or multiple numerologies (e.g., at least 2 numerologies). For example, FR2 may be associated with a third numerology (e.g., u=2), which includes 60 kHz subcarrier spacing; and a fourth numerology (e.g., u=3), which includes 120 kHz subcarrier spacing.

According to implementations, one or more of the NEs 102 and the UEs 104 are operable to implement various aspects of the techniques described with reference to the present disclosure. For example, a UE 104 can receive, from a NE 102, first configuration associated with a RLC entity of the UE, where autonomous retransmission for the RLC entity of the UE is enabled or disabled according to the first configuration and based at least in part on one or more conditions. Further, the UE 104 can receive, from the NE 102, a second configuration associated with the RLC entity of the UE, where the second configuration indicates a timer associated with the autonomous retransmission for the RLC entity. The UE 104 can autonomously retransmit a first subset of one or more RLC PDUs based at least in part on the one or more conditions, start the timer in accordance with the second configuration and in response to the autonomously retransmitted first subset of one or more RLC PDUs, and prohibit a subsequent autonomous retransmission for the RLC entity until expiry of the timer.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

With reference to extended Reality (XR) in wireless communications systems, proposals have been discussed which include enhancements in the user plane. Currently, the packet data convergence protocol (PDCP) and RLC layers in the user plane protocol stack function independently from each other. On the receiving side, the PDCP layer maintains a reordering window to receive PDCP PDUs and transmit them to higher layers. While in RLC, the RLC receiving entity maintains a reception window to receive RLC PDUs and transmit them to higher layers. In PDCP, the reordering window is controlled by a t-Reordering timer that is configured by RRC. When this timer expires, it causes the reordering window to slide forward, e.g., update the lower bound of the reordering window. If a packet is received outside of this reordering window, it is discarded by the PDCP receiving entity. In RLC acknowledged mode (AM) Mode, the receiving entity slides its reception window when the lowest packet in the window (e.g., packet with sequence number (SN) that matches the lower bound of the RLC AM reception window) has been completely received and an acknowledgement has been sent for the same. As the PDCP and RLC layers can function independently, the reception window and reordering window may not be updated at the same time. If the PDCP reordering window moves forward while the RLC window is not updated, the RLC layer may transmit packets to the PDCP layer that are outside of the reordering window leading to discard of such packets.

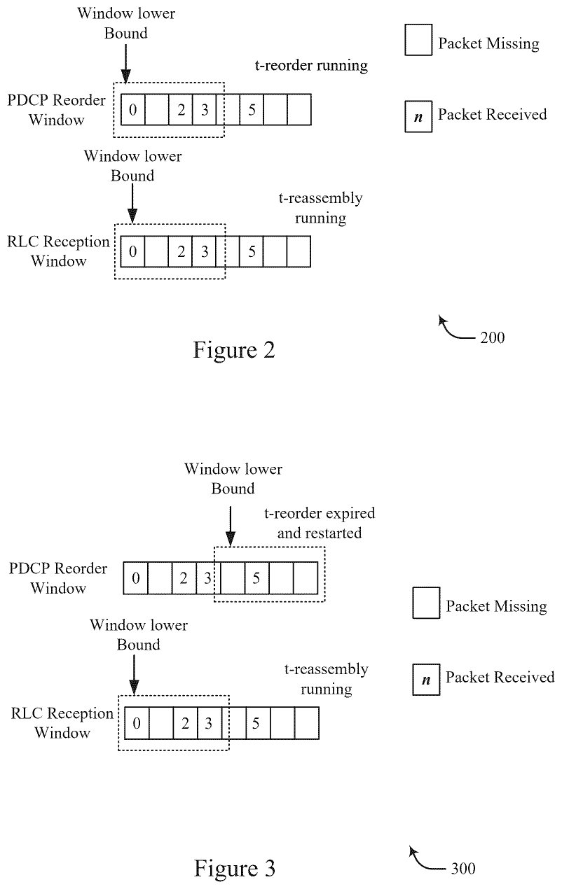

FIG. 2 illustrates a scenario 200 for PDCP and RLC reception. The scenario 200, for instance, shows the reordering window in PDCP and reception window in RLC AM mode wherein the lower bounds of both windows are expecting PDU with SN=0 (COUNT=0 in case of PDCP wherein COUNT=[Hyper Frame Number (HFN), sequence number (SN)]). In the scenario 200, the RLC receiving entity has correctly and fully received packets numbered 0, 2 and 3, and hence transmitted this to PDCP layer. PDCP has also received packets numbered 0, 2 and 3, with a missing packet numbered 1. Hence the PDCP receiving entity starts the t-Reordering timer when it receives packet 2 before 1. While in RLC, the t-reassembly timer is started since one or more segments of packet 1 are not received yet. When the t-Reordering timer expires, the PDCP reordering window updates its lower bound to the next packet that has not been consecutively received.

FIG. 3 illustrates a scenario 300 for PDCP and RLC Reception after t-Reordering expiry. For example, in the scenario 300, packet 4 is the next packet that has not been consecutively received after the t-Reordering expired. Hence, the lower bound of the PDCP reordering window is moved to packet 4, whereas in RLC, the t-reassembly only triggers a status report upon expiry and the reception window does not update unless the status report contains an ACK for packet 1. Since the RLC receiving entity has not received packet 1, the RLC receiving entity still tries to recover the packet by means of (re) transmissions. Once the packet is recovered by the RLC, the RLC transmits this to PDCP which may discard the packet as it is outside of the reordering window. These redundant transmissions are not only a waste of resources but can also add latency on the user plane.

Enhancements to the RLC AM mode have been discussed with one of the approaches being considered includes enabling autonomous retransmissions to achieve timely retransmissions on RLC layer for XR traffic, including Autonomous retransmission (e.g., without status report) of PDUs based on some triggers and existing or new triggers can be considered), retransmission based on enhanced status report, and retransmission based on enhanced polling.

In implementations, autonomous retransmissions refer to those retransmissions that are triggered at the RLC transmitter without the transmitter receiving a status report (e.g., indicating a NACK) from a peer entity. One issue with autonomous retransmissions is that they may quickly congest the link if the RLC transmits unnecessary autonomously retransmitted packets. This may further aggravate the delay encountered in data transmission. Another problem faced with autonomous retransmissions is that it may be redundant if triggered too early, e.g., before the initial transmission was received by the peer entity and/or if a packet was already ACKed but the RLC has not yet received the ACK. This redundancy can lead to reduced throughput and resource wastage. Further, the MAC HARQ may also be simultaneously attempting to recover and/or correctly decode a TB when an autonomous retransmission is triggered in RLC. If the MAC HARQ is successful in decoding a TB consisting of an RLC PDU that was also autonomously retransmitted, the autonomous retransmission remains redundant leading to resource wastage, reduced throughput, and increased latencies.

When a PDCP window advances, it may do so even with some missing packets in between whereas the RLC receiving entity only advances its window once the reception of a packet is confirmed by sending an acknowledgement to the transmitting entity. In RLC AM Mode, the RLC receiver may try to recover missing packets even if the PDCP would discard the missing packets. This can lead to unnecessary latencies as well as resource wastages. To avoid such issues, some solutions may decouple the reordering window from the t-Reordering timer. By decoupling the reordering window from t-Reordering, the advancement of the reordering window may be automatic based on when it completely receives a PDCP PDU. In some implementations, this may be achieved by setting the t-Reordering value to infinity such that it never expires. The reordering window can be allowed to transmit all PDUs that it receives to higher layer immediately (provided header decompression is performed if not already decompressed) after it receives the packet if outOfOrderDelivery is configured. If outOfOrderDelivery is not configured, the reordering window may only update as and when it receives a PDU with a COUNT value consecutive to that of the COUNT value. The RX_DELIV state variable indicates the COUNT value of the first PDCP service data unit (SDU) not delivered to the upper layers but still waited for, e.g., it is the COUNT value of the lower bound of the reordering window.

In another implementation, the advancement of the reordering window may be achieved by removing the t-Reordering timer maintained by the PDCP receiver, e.g., the RRC no longer configures such a timer for the PDCP receiving entity and the reordering window only works based on the reception of PDCP PDUs and whether or not outOfOrderDelivery is configured. In yet another implementation, the t-Reordering timer may still be configured by the RRC with a non-infinity value, but it does not affect the lower bound of the reordering window. The timer may only be configured if outOfOrderDelivery has not been configured. The timer may only dictate the time allowed by the receiving entity to deliver the received PDUs in order. The timer is started when a PDU is received by the PDCP receiving entity out of order. Once the timer expires, the receiving entity may deliver all the PDUs received until the expiry of the timer regardless of whether it is in order or not. The reordering window may then wait till it recovers the missing packets before it can advance its lower bound and restart the t-Reordering timer.

Although this solution may work well to synchronize the reorder and reception windows in PDCP and RLC respectively, it has disadvantages that make it a non-optimal solution: (1) The solution may not work well for packets may small packet delay budget (PDB)/PDU set delay budget (PSDB) as the receiving entity on PDCP may now take more time to recover all PDUs that it expects (unless a RRC reestablishment can be done due to RLF); (2) The overall latency on the user plane can be increased; (3) The RLC and PDCP may require more resources to recover all packets that it expects to be received.

Due to such disadvantages, a solution may be needed that is more optimal in terms of resource utilization as well as latency to make the user plane functionality as efficient as possible for services such XR that are extremely delay-sensitive. Furthermore, some conditions have been provided for an autonomous retransmission approach as follows: If configured by network, a RLC AM transmitter can retransmit a RLC PDU if one of the following conditions is met: after the remaining time of the PDU has dropped below a configured threshold; or after the PDU has failed a configured number of HARQ transmissions; or if the PDU is in the RLC retransmission buffer and there are spare physical uplink shared channel (PUSCH) resources available after the logical channel prioritization (LCP) procedure. In carrier aggregation (CA) configuration, network can configure a separate logical channel (LCH) for RLC retransmissions triggered according to the first two conditions.

The present disclosure provides further conditions and/or triggers that may be used to restrict autonomous retransmissions to specific scenarios, such as to maintain efficiency for latency and resource utilization. Furthermore, the present disclosure discusses optimizations in RLC and MAC to prevent additional congestion on the user-plane due to autonomous retransmissions.

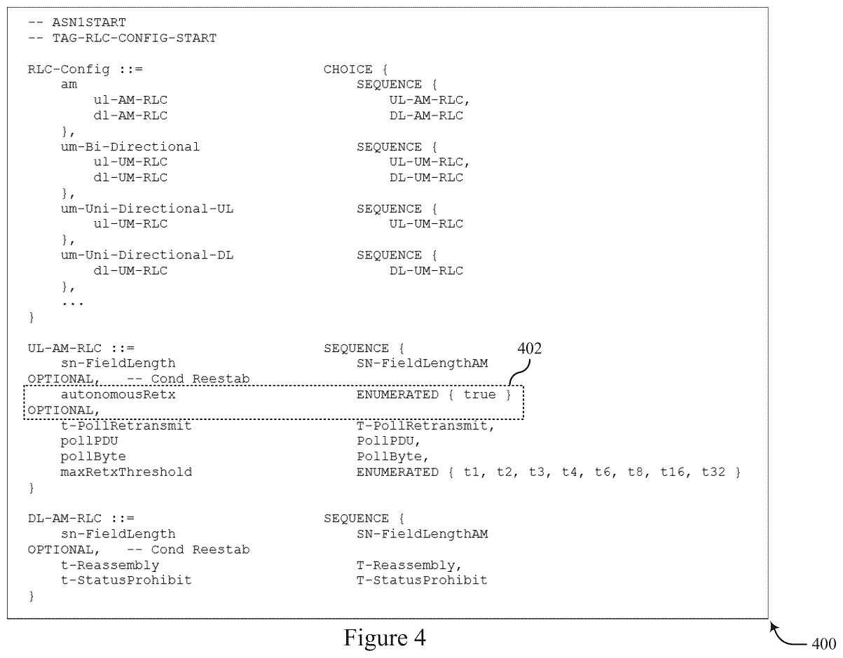

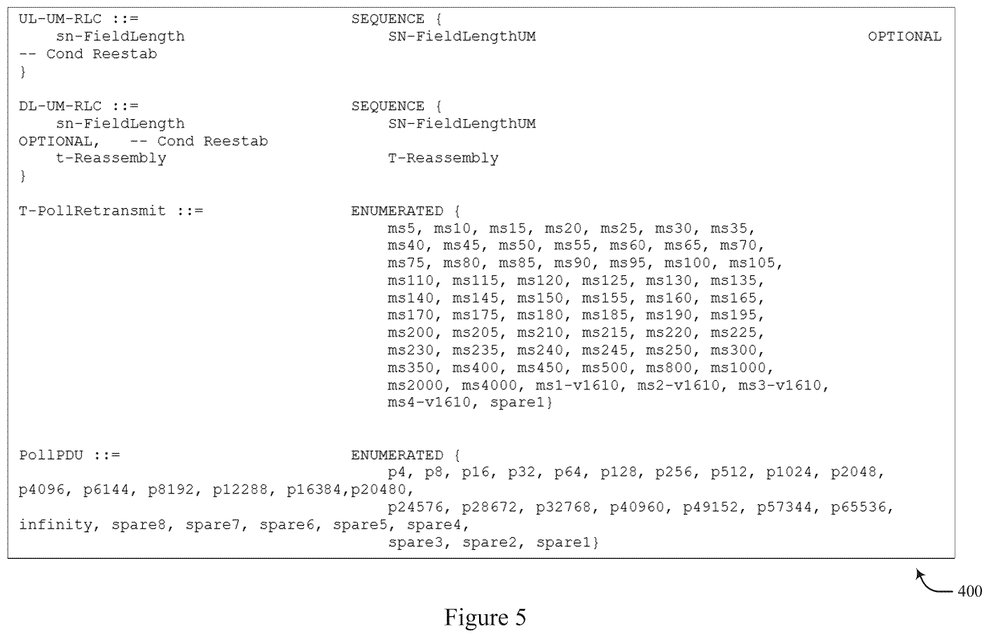

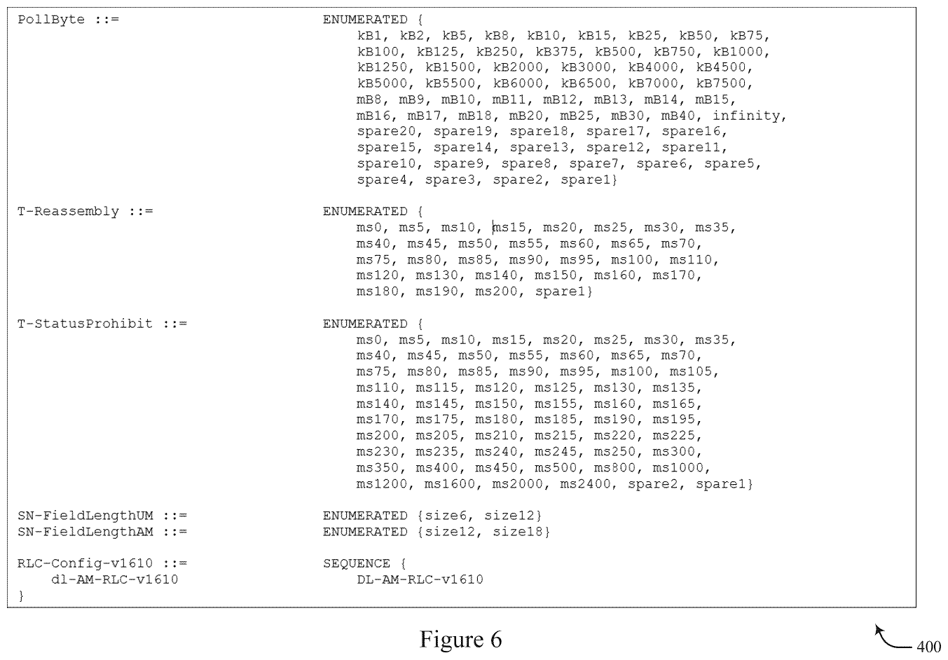

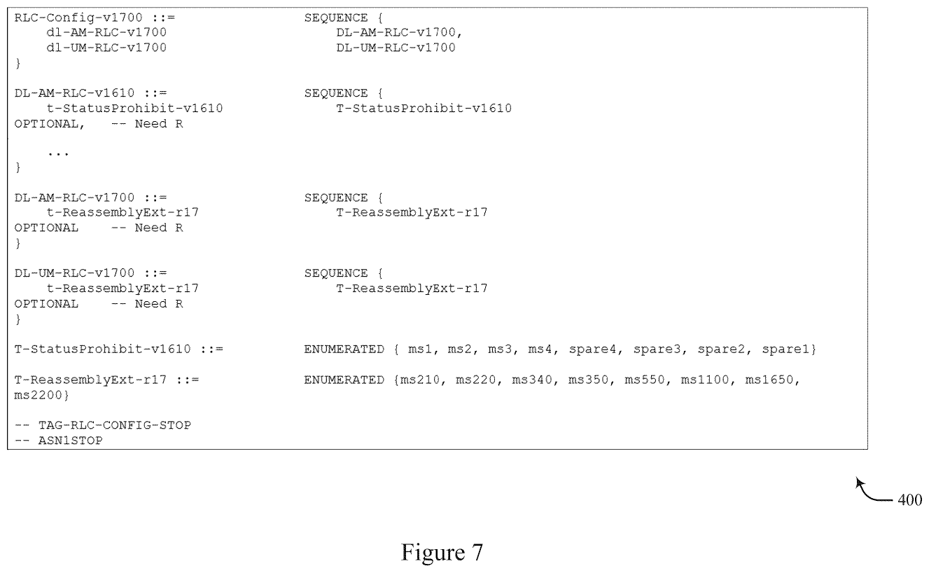

FIGS. 4-7 illustrate an example information element 400 in accordance with aspects of the present disclosure. The information element 400, for instance, represents a RLC-Config information element in RRC. In implementations, autonomous retransmissions in RLC may be configured for an RLC entity by RRC. For instance, a RLC entity configured with autonomous retransmission may retransmit RLC PDU(s) autonomously without waiting for a status report from its peer entity. In implementations, this configuration may be introduced as a parameter 402 (e.g., autonomousRetx) within the information element 400 (e.g., RLC-Config Information Element) in RRC. In one example, the parameter 402 may be configured as an enumerated ‘true’ or ‘false’. The absence of the parameter 402 may also implicitly indicate that autonomous retransmissions is not configured for a RLC entity.

In implementations, the autonomous retransmissions in RLC may also be based on the PSI value of a packet, wherein autonomous retransmissions may be constrained to those RLC PDU(s) that are indicated as high importance from higher layers and/or have a PSI value greater than a new PSI threshold (e.g., PSIforAutoRetx). That is, only those packets with PSI value greater than PSIforAutoRetx can be applicable to be autonomously retransmitted when autonomous retransmissions is configured/enabled. In implementations, autonomous retransmissions for a RLC entity may be implicitly disabled when network indicates congestion on the user-plane and/or when PSI-based discard is enabled. For instance, when the link is congested, autonomous retransmissions can be disabled to prevent further congestion on the link.

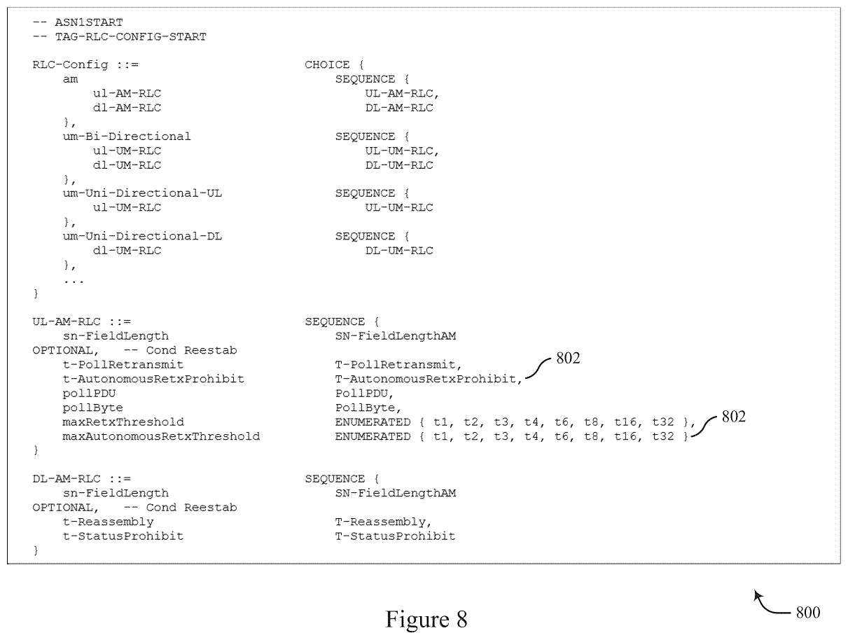

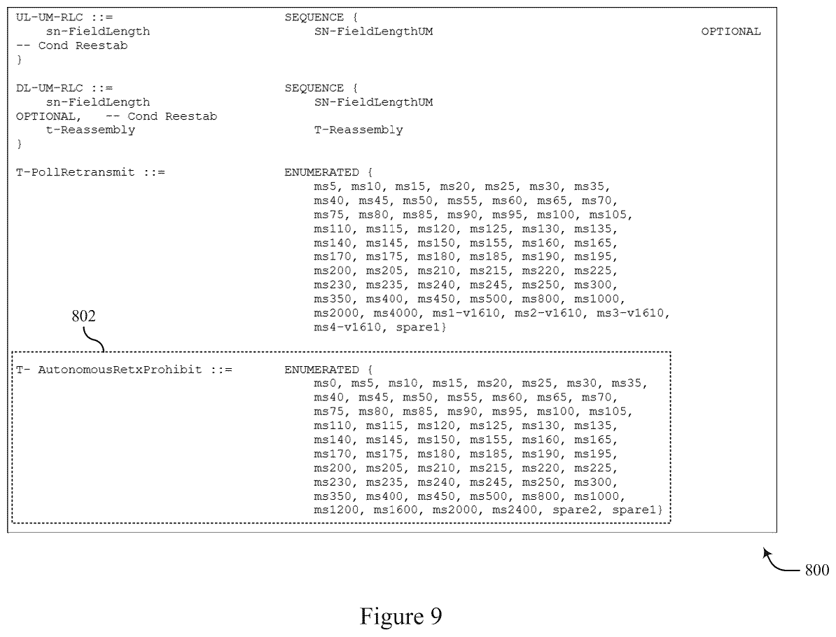

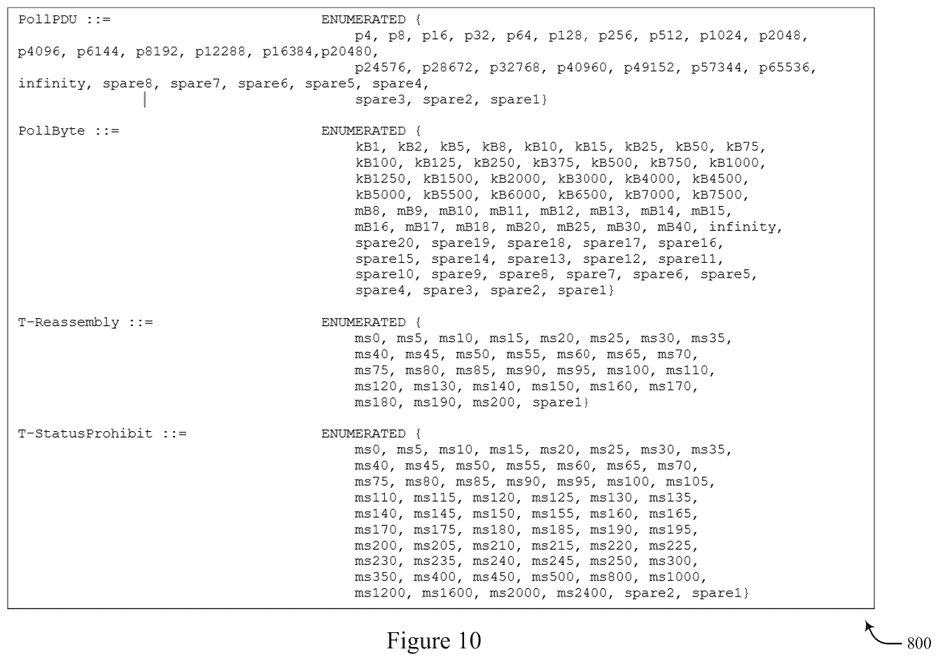

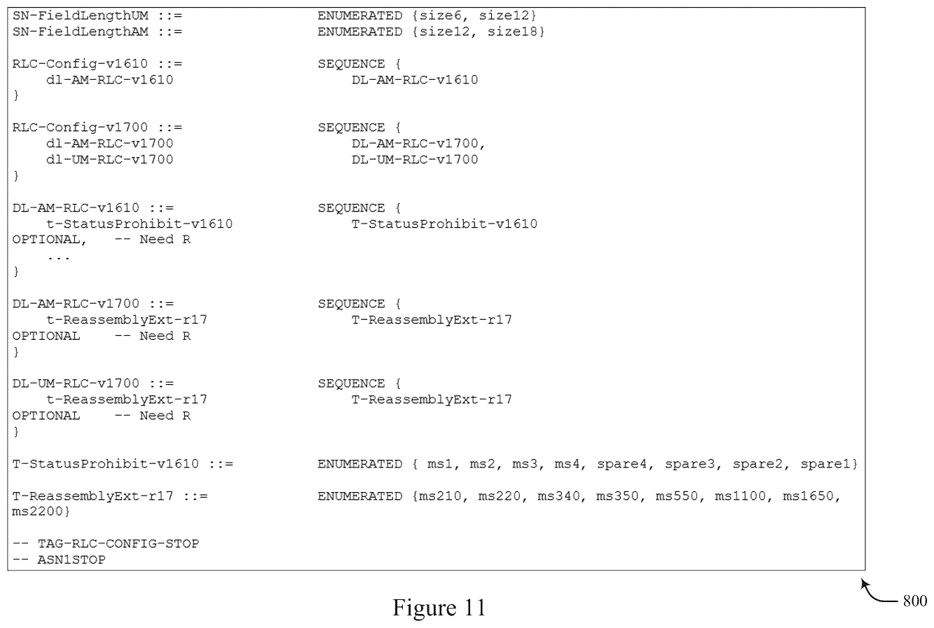

FIGS. 8-11 illustrate an example information element 800 in accordance with aspects of the present disclosure. The information element 800, for instance, represents a RLC-Config information element in RRC. Implementations, for example, provide for RLC behavior after receiving a NACK. For instance, the RLC transmitter may maintain an additional timer (e.g., t-AutonomousRetxProhibit) as configured by RRC to prevent triggering multiple retransmissions. For example, when RLC has already triggered an autonomous retransmission of one or more RLC PDU(s) and a NACK is received for one or more of those PDU(s), a second retransmission of the same PDU(s) is not to be transmitted until the expiry of the t-AutonomousRetxProhibit timer. This timer can be started upon an autonomous retransmission of one or more RLC PDU(s). In one example, there may be more than one t-AutonomousRetxProhibit running for a RLC entity such as on a per autonomously retransmitted PDU basis. While this timer is running, the RLC transmitter is not to retransmit the PDU(s) corresponding to the timer regardless of whether any retransmission criteria are satisfied, e.g., either as a legacy retransmission or a second autonomous retransmission.

According to one implementation, if a RLC PDU is already autonomously retransmitted, another new retransmission is not triggered/transmitted unless the RLC transmitter receives a NACK in response to the previously transmitted autonomous retransmission. In one example, the RLC transmitter may maintain a time window after the submission of an autonomous retransmission to lower layers where if a status report is received within this window containing a NACK for RLC PDU(s) that started this time window, a new retransmission is not triggered unless the RLC transmitter receives a second NACK corresponding to these PDU(s). Additionally, the RLC transmitter may also maintain a threshold (e.g., maxAutonomousRetxThreshold) and a counter (e.g. AUTORETX_COUNT) for the maximum number of autonomous retransmissions of a RLC PDU as configured by RRC. The RLC transmitter can increment the counter for each autonomous retransmission until maxAutonomousRetxThreshold is reached. When this threshold is satisfied, the RLC transmitter can inform higher layers that the threshold is met. In one example, the RLC may further initiate RLF procedure when the threshold is satisfied.

In implementations, the RLC transmitter can increase the legacy RETX_COUNT when an autonomous retransmission is submitted to lower layers and the legacy maxRetxThreshold is used to limit the maximum number of retransmissions allowed, e.g., legacy retransmissions based on status report as well as autonomous retransmissions. In implementations, the number of autonomous retransmissions for a RLC PDU can be limited to 1. For instance, after the initial transmission of a RLC PDU, the transmitter only autonomously retransmits the PDU up to one time based on whether the autonomous retransmission triggering conditions are satisfied. Additional retransmissions of the PDU can be based on legacy procedure e.g., due to a NACK received in a status report). In this implementation the RLC transmitter may or may not be configured with the t-AutonomousRetxProhibit. The information element 800 includes parameters 802 for RLC behavior after receiving a NACK.

In implementations, when RLC has already triggered an autonomous retransmission of one or more RLC PDU(s) and an ACK is received for one or more of those PDU(s), the RLC may discard those PDU(s) for which an ACK is received. When autonomously retransmitted PDU(s) have not yet been submitted to lower layers, the RLC transmitter may cancel the autonomous retransmission and discard the RLC PDU(s) that are ACKed. Additionally, if the autonomously retransmitted PDU(s) were already submitted to lower layers, the RLC transmitter may inform the MAC entity of the PDU(s) that no longer need to be retransmitted (e.g., due to the reception of an ACK) by means of inter-layer communication. The MAC entity may further discard these packets if they had not yet been transmitted in a TB.

Implementations also provide for prioritization of autonomously retransmitted PDUs. According to implementations, autonomously retransmitted RLC PDU(s) can be given priority for submission to lower layers. For instance, at a transmission opportunity indicated by lower layers, RLC PDU(s) containing data for autonomous retransmission can be prioritized over RLC PDU(s) pending legacy retransmission and initial transmissions by the RLC transmitter. Further, the MAC can perform a three-step LCP procedure on packets indicated as autonomously retransmitted wherein the first round of uplink (UL) resources are allocated to those LCHs carrying autonomously retransmitted PDU(s) pending in the buffer in decreasing order of LCH priority. The second and third rounds can be performed according to legacy LCP procedure, e.g., prioritized bit rate (PBR) based UL resource allocation and strict priority-based resource allocation regardless of the value of Bj.

According to one implementation, UE/MAC considers a LCH as eligible for the first round of the enhanced LCP procedure if there is at least one PDU/SDU in the LCH for which the remaining time till discardTimer expiry is less than a threshold. In another implementation, the RLC may explicitly indicate the PDU(s) that have been autonomously retransmitted as part of inter-layer communication to MAC. It should be noted that the threshold may be a different threshold than remaining TimeThreshold configured for the delay status reporting, or different from a threshold for delay-criticality. The MAC entity can allocate uplink resources to a LCH until either all the autonomously retransmitted data been multiplexed in the UL grant or the UL grant is exhausted.

In implementations, the UE/MAC entity can determine the priority of a LCH for the purpose of an enhanced LCP procedure where the transmission of autonomously retransmitted data is prioritized before the enhanced LCP procedure is performed. For instance, the UE/MAC uses a legacy LCP procedure and can adapt the priority of a LCH based on at least partly the remaining time of PDUs/SDUs of the LCH. According to one implementation, the priority of a LCH is determined based on the configured LCH priority and the remaining time of PDUs/SDUs of the LCHs. As per one aspect, the LCH priority is determined before the LCP procedure and may not be adapted while LCP is performed.

In implementations, the UE/MAC entity can determine the priority of a LCH for the purpose of an enhanced LCP procedure before the first round of LCP and before the second of LCP procedure. For instance, the UE/MAC may use different priorities for an LCH during the LCP procedure, e.g. a first LCH priority is used for the first round of resource allocation (satisfying PBR requirement) and the second round of resource allocation where remaining uplink resources are assigned in a decreasing priority order. In at least one example the UE/MAC uses a legacy LCP procedure and adapts the priority of a LCH based on at least partly the remaining time of PDUs/SDUs of the LCH. An advantage of determining the priority of a LCH (again) for the second round of LCP procedure can be that the delay-critical data may been already multiplexed into the TB/MAC PDU during the first round of LCP, e.g. for the first round of LCP the priority of a LCH carrying autonomously retransmitted data is increased/set to a high priority value. If there is no such data available for transmission for that LCH after the first round of LCP, the UE/MAC entity can use the configured LCH priority for the second round of LCP.

Implementations provide for accommodating HARQ procedures when autonomous retransmission is enabled. For instance, the priority of a HARQ process can be determined by considering the remaining delay of autonomously retransmitted data that is multiplexed or that can be multiplexed in a MAC PDU according to mapping restrictions. According to one implementation, the UE/MAC can prioritize a HARQ process ID with autonomously retransmitted data over other HARQ processes. In one example the UE/MAC can prioritize a HARQ process where the smallest remaining delay of the data that is multiplexed or can be multiplexed in the corresponding MAC PDU is below a preconfigured threshold in order to prevent delays in transmitting such data.

In implementations, the MAC entity may maintain information of the autonomously retransmitted PDUs including the TBs on which the PDUs were transmitted. For instance, the RLC can inform the MAC of the autonomously retransmitted PDU(s) by means of inter-layer communication. The UE/MAC may then inform the RLC transmitter if it receives a HARQ ACK (e.g., explicit ACK or toggled new data indicator (NDI)) for the TB that included these PDU(s) in order to prevent additional retransmissions from being triggered. The RLC transmitter may also discard the packets that were ACK′ed by MAC, e.g., from the HARQ feedback by explicit ACK or toggled NDI.

In implementations, when autonomous retransmission is enabled for a RLC entity, the UE/MAC can track the RLC PDU(s) that it receives including the TBs on which these PDU(s) are transmitted. For PDUs that are ACK'ed in the HARQ feedback (e.g., explicit ACK or toggled NDI), the UE/MAC can inform the RLC transmitter of the ACK'ed PDUs by means of inter-layer communication. The RLC transmitter may accordingly prohibit triggering an autonomous retransmission for the PDU(s) that were indicated as ACK'ed by MAC and may discard the PDU packets.

Regarding PDCP control PDUs, one solution to avoid unnecessary retransmissions in RLC is by configuring a new timer in the RLC receiving entity (e.g., t-Receive) to control the receiving window such that upon expiry of this timer. For instance, the receiving window in RLC can be updated in accordance with the PDCP reception window (e.g., as per the expiry of t-Reordering). The timer can be started upon the delivery of a RLC PDU(s) out of sequence to higher layers and can be stopped when a packet is successfully received and delivered by the RLC. One issue with this solution is that the PDCP control PDU(s) (e.g., PDCP SN gap report, the robust header compression (ROHC) interspersed feedback, EHC feedback, etc.) that are associated with a RLC SN may cause the start of a timer if the RLC receiver does not receive them before a RLC SDU with a higher RLC SN, e.g., the RLC receiver receives a RLC SDU corresponding to a PDCP Control PDU out of order. If the timer runs out, the RLC receiver can stop attempting to recover the RLC SDU associated with the PDCP Control PDU and inform its peer entity to update the transmission window accordingly. This can cause the discard of a RLC SDU corresponding to a PDCP Control PDU without the RLC SDU being correctly received and delivered by the RLC layer.

In implementations, the PDCP transmitter can inform the RLC transmitter by means of inter-layer communication when the RLC SDU corresponds to a PDCP control PDU. The RLC transmitter may then inform its peer entity of the RLC SNs corresponding to PDCP Control PDU(s) by means of a RLC Control PDU such that the RLC receiver delivers the RLC PDU(s) indicated within the control PDU to higher layers regardless of whether the t-Receive timer has expired. In one aspect, the RLC receiving window is not updated even upon the expiry of t-Receive if the timer was started due to a PDCP Control PDU related RLC SDU. In another aspect, the RLC receiver delivers a RLC PDU to higher layers if the RLC receiver had been indicated as a PDCP Control PDU related SDU by its peer entity, regardless of whether this RLC PDU falls out of the receiving window, e.g., due to the receiving window being updated upon expiry of the t-Receive. In yet another aspect, the RLC receiver may not start the t-Receive timer for those RLC SNs indicated by its peer entity in this new control PDU, if not received in order.

In implementations, instead of inter-layer communication, the RLC transmitter can performs a packet inspection of the SDU received from PDCP. If the SDU is identified as a PDCP Control PDU, the RLC transmitter may indicate this to its peer entity by means of a new RLC control PDU as disclosed above. In one aspect, instead of a new control PDU at RLC, the RLC transmitter can include an additional flag bit in its header as an indication to its peer entity that this RLC SDU corresponds to a PDCP Control PDU. In yet another implementation, the RLC transmitter side works as per legacy behavior and the RLC receiver performs a packet inspection to identify RLC SDU associated with a PDCP Control PDU.

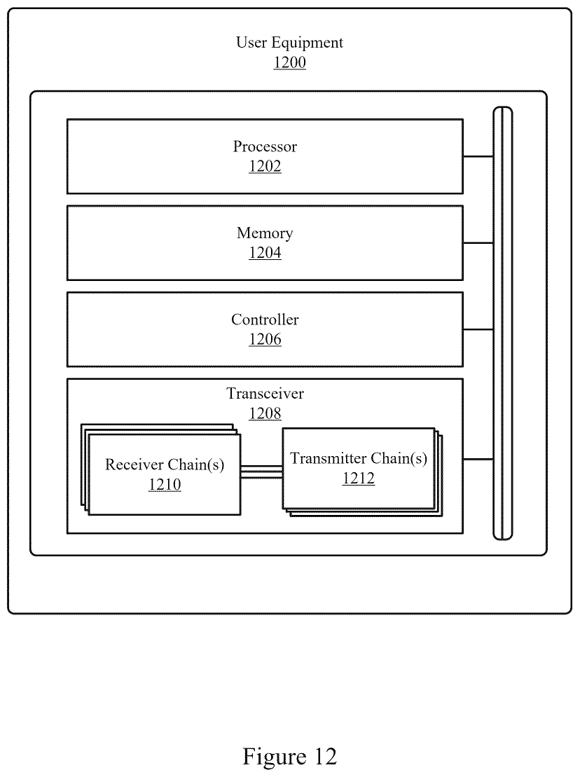

FIG. 12 illustrates an example of a UE 1200 in accordance with aspects of the present disclosure. The UE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the UE 1200 to perform various functions of the present disclosure.

The memory 1204 may include volatile or non-volatile memory. The memory 1204 may store computer-readable, computer-executable code including instructions when executed by the processor 1202 cause the UE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the UE 1200 to perform one or more of the functions described herein (e.g., executing, by the processor 1202, instructions stored in the memory 1204). For example, the processor 1202 may support wireless communication at the UE 1200 in accordance with examples as disclosed herein. The UE 1200 may be configured to or operable to support a means for receiving a first configuration associated with a RLC entity of the UE, wherein autonomous retransmission for the RLC entity of the UE is enabled or disabled according to the first configuration and based at least in part on one or more conditions; receiving a second configuration associated with the RLC entity of the UE, wherein the second configuration indicates a timer associated with the autonomous retransmission for the RLC entity; autonomously retransmitting a first subset of one or more RLC PDUs based at least in part on the one or more conditions; starting the timer in accordance with the second configuration and in response to the autonomously retransmitted first subset of one or more RLC PDUs; and prohibiting a subsequent autonomous retransmission for the RLC entity until expiry of the timer.

Additionally, the UE 1200 may be configured to support any one or combination of the second configuration further indicates a threshold number of autonomous retransmissions, the one or more conditions include the threshold number of autonomous retransmissions, and the first subset of one or more RLC PDUs is autonomously retransmitted based at least in part on the threshold number of autonomous retransmissions; the first configuration includes a parameter for enabling or disabling the autonomous retransmission for the RLC entity; the first configuration including the parameter for enabling or disabling the autonomous retransmission for the RLC entity is received via a RRC message; further including determining that the autonomous retransmission for the RLC entity of the UE is disabled based at least in part on an absence of a parameter in the received first configuration; further including: identifying a network congestion level based at least in part on an indication, or identify that PSI discarding is enabled, or both, wherein at least one condition of the one or more conditions includes the identified network congestion level, or the identified discarding for the RLC entity of the UE being enabled, wherein the subsequent autonomous retransmission for the RLC entity is prohibited based at least in part on the identified network congestion level, or the identified discarding for the RLC entity of the UE being enabled.

Additionally, the UE 1200 may be configured to support any one or combination of further including: identifying that the autonomous retransmission for the RLC entity of the UE is applicable for RLC PDUs associated with a priority, wherein at least one condition of the one or more conditions includes the priority, wherein the first subset of one or more RLC PDUs is autonomously retransmitted based at least in part on a corresponding priority associated with each RLC PDU of the first subset of one or more RLC PDUs satisfying the priority; further including: identifying that the autonomous retransmission for the RLC entity of the UE is applicable for RLC PDUs associated with a corresponding PSI value, wherein the corresponding PSI value is greater than a PSI threshold value, wherein the first subset of one or more RLC PDUs is autonomously retransmitted based at least in part on a respective PSI value of each RLC PDU of the first subset of one or more RLC PDUs satisfying the PSI threshold value; further including: triggering the subsequent autonomous retransmission for the RLC entity of the UE, wherein the subsequent autonomous retransmission includes a second subset of one or more RLC PDUs; receiving an ACK for the second subset of one or more RLC PDUs; and discarding the second subset of one or more RLC PDUs based at least in part on the received ACK, wherein the second subset of one or more RLC PDUs comprises of one or more RLC PDUs for which autonomous retransmission has been triggered prior to reception of the ACK.

Additionally, the UE 1200 may be configured to support any one or combination of further including prioritizing the first subset of one or more RLC PDUs for the autonomous retransmission over a second subset of one or more RLC PDUs pending a non-autonomous retransmission and one or more initial RLC PDU transmissions; further including prioritizing allocation of uplink resources for one or more logical channels carrying one or more autonomously retransmitted RLC PDUs over allocation of uplink resources for one or more logical channels carrying non-autonomously retransmitted RLC PDUs; further including prioritizing a HARQ process associated with one or more autonomously retransmitted RLC PDUs over one or more other HARQ processes; further including: communicating information identifying the one or more first RLC PDUs that are autonomously retransmitted; receiving an indication of a HARQ ACK for a TB associated with the one or more first RLC PDUs; and prohibiting, based at least in part on the HARQ ACK, triggering an additional autonomous retransmission of the one or more first RLC PDUs; further including: receiving, via inter-layer communication, an indication of a HARQ ACK for the one or more first RLC PDUs; and prohibiting, based at least in part on the HARQ ACK, triggering an autonomous retransmission of the one or more first RLC PDUs.

Additionally, or alternatively, the UE 1200 may support at least one memory (e.g., the memory 1204) and at least one processor (e.g., the processor 1202) coupled with the at least one memory and configured to cause the UE to receive a first configuration associated with a RLC entity of the UE, wherein autonomous retransmission for the RLC entity of the UE is enabled or disabled according to the first configuration and based at least in part on one or more conditions; receive a second configuration associated with the RLC entity of the UE, wherein the second configuration indicates a timer associated with the autonomous retransmission for the RLC entity; autonomously retransmit a first subset of one or more RLC PDUs based at least in part on the one or more conditions; start the timer in accordance with the second configuration and in response to the autonomously retransmitted first subset of one or more RLC PDUs; and prohibit a subsequent autonomous retransmission for the RLC entity until expiry of the timer.

Additionally, the UE 1200 may be configured to support any one or combination of the second configuration further indicates a threshold number of autonomous retransmissions, the one or more conditions include the threshold number of autonomous retransmissions, and the first subset of one or more RLC PDUs is autonomously retransmitted based at least in part on the threshold number of autonomous retransmissions; the first configuration includes a parameter for enabling or disabling the autonomous retransmission for the RLC entity; the first configuration including the parameter for enabling or disabling the autonomous retransmission for the RLC entity is received via a RRC message; the at least one processor is further configured to cause the UE to determine that the autonomous retransmission for the RLC entity of the UE is disabled based at least in part on an absence of a parameter in the received first configuration; the at least one processor is configured to cause the UE to: identify a network congestion level based at least in part on an indication, or identify that PSI discarding is enabled, or both, wherein at least one condition of the one or more conditions includes the identified network congestion level, or the identified discarding for the RLC entity of the UE being enabled, wherein the subsequent autonomous retransmission for the RLC entity is prohibited based at least in part on the identified network congestion level, or the identified discarding for the RLC entity of the UE being enabled.

Additionally, the UE 1200 may be configured to support any one or combination of the at least one processor is configured to cause the UE to: identify that the autonomous retransmission for the RLC entity of the UE is applicable for RLC PDUs associated with a priority, wherein at least one condition of the one or more conditions includes the priority, wherein the first subset of one or more RLC PDUs is autonomously retransmitted based at least in part on a corresponding priority associated with each RLC PDU of the first subset of one or more RLC PDUs satisfying the priority; the at least one processor is configured to cause the UE to: identify that the autonomous retransmission for the RLC entity of the UE is applicable for RLC PDUs associated with a corresponding PSI value, wherein the corresponding PSI value is greater than a PSI threshold value, wherein the first subset of one or more RLC PDUs is autonomously retransmitted based at least in part on a respective PSI value of each RLC PDU of the first subset of one or more RLC PDUs satisfying the PSI threshold value; the at least one processor is configured to cause the UE to: receive an ACK for a second subset of one or more RLC PDUs; and discard the second subset of one or more RLC PDUs based at least in part on the received ACK, wherein the second subset of one or more RLC PDUs comprises of one or more RLC PDUs for which autonomous retransmission has been triggered prior to reception of the ACK; the at least one processor is configured to cause the UE to prioritize the first subset of one or more RLC PDUs for the autonomous retransmission over a second subset of one or more RLC PDUs pending a non-autonomous retransmission and one or more initial RLC PDU transmissions.

Additionally, the UE 1200 may be configured to support any one or combination of the at least one processor is configured to cause the UE to prioritize allocation of uplink resources for one or more logical channels carrying one or more autonomously retransmitted RLC PDUs over allocation of uplink resources for one or more logical channels carrying non-autonomously retransmitted RLC PDUs; the at least one processor is configured to cause the UE to prioritize a HARQ process associated with one or more autonomously retransmitted RLC PDUs over one or more other HARQ processes; the at least one processor is configured to cause the UE to: communicate information identifying the one or more first RLC PDUs that are autonomously retransmitted; receive an indication of a HARQ ACK for a TB associated with the one or more first RLC PDUs; and prohibit, based at least in part on the HARQ ACK, triggering an additional autonomous retransmission of the one or more first RLC PDUs; the at least one processor is configured to cause the UE to: receive, via inter-layer communication, an indication of a HARQ ACK for the one or more first RLC PDUs; and prohibit, based at least in part on the HARQ ACK, triggering an autonomous retransmission of the one or more first RLC PDUs.

The controller 1206 may manage input and output signals for the UE 1200. The controller 1206 may also manage peripherals not integrated into the UE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the UE 1200 may include at least one transceiver 1208. In some other implementations, the UE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

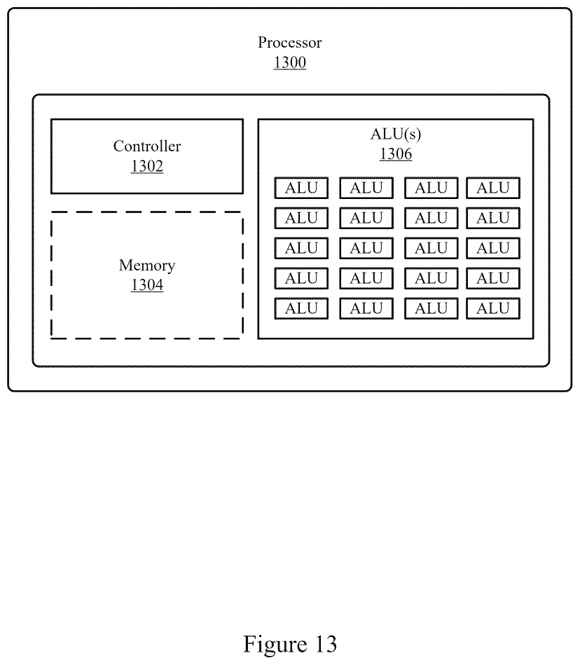

FIG. 13 illustrates an example of a processor 1300 in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, which may be, for example, an L1/L2/L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory addresses of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage flow of data within the processor 1300. The controller 1302 may be configured to control transfer of data between registers, ALUs 1306, and other functional units of the processor 1300.

The memory 1304 may include one or more caches (e.g., memory local to or included in the processor 1300 or other memory, such as RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, and the controller 1302, and may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 may be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

The processor 1300 may support wireless communication in accordance with examples as disclosed herein. The processor 1300 may be configured to or operable to support at least one controller (e.g., the controller 1302) coupled with at least one memory (e.g., the memory 1304) and configured to cause the processor to receive a first configuration associated with a RLC entity of a UE, wherein autonomous retransmission for the RLC entity of the UE is enabled or disabled according to the first configuration and based at least in part on one or more conditions; receive a second configuration associated with the RLC entity of the UE, wherein the second configuration indicates a timer associated with the autonomous retransmission for the RLC entity; autonomously retransmit a first subset of one or more RLC PDUs based at least in part on the one or more conditions; start the timer in accordance with the second configuration and in response to the autonomously retransmitted first subset of one or more RLC PDUs; and prohibit a subsequent autonomous retransmission for the RLC entity until expiry of the timer.

Additionally, the processor 1300 may be configured to or operable to support any one or combination of the second configuration further indicates a threshold number of autonomous retransmissions, the one or more conditions include the threshold number of autonomous retransmissions, and the first subset of one or more RLC PDUs is autonomously retransmitted based at least in part on the threshold number of autonomous retransmissions; the first configuration includes a parameter for enabling or disabling the autonomous retransmission for the RLC entity; the first configuration including the parameter for enabling or disabling the autonomous retransmission for the RLC entity is received via a RRC message; the at least one controller is further configured to cause the processor to determine that the autonomous retransmission for the RLC entity of the UE is disabled based at least in part on an absence of a parameter in the received first configuration; the at least one controller is configured to cause the processor to: identify a network congestion level based at least in part on an indication, or identify that PSI discarding is enabled, or both, wherein at least one condition of the one or more conditions includes the identified network congestion level, or the identified discarding for the RLC entity of the UE being enabled, wherein the subsequent autonomous retransmission for the RLC entity is prohibited based at least in part on the identified network congestion level, or the identified discarding for the RLC entity of the UE being enabled.

Additionally, the processor 1300 may be configured to or operable to support any one or combination of the at least one controller is configured to cause the processor to: identify that the autonomous retransmission for the RLC entity of the UE is applicable for RLC PDUs associated with a priority, wherein at least one condition of the one or more conditions includes the priority, wherein the first subset of one or more RLC PDUs is autonomously retransmitted based at least in part on a corresponding priority associated with each RLC PDU of the first subset of one or more RLC PDUs satisfying the priority; the at least one controller is configured to cause the processor to: identify that the autonomous retransmission for the RLC entity of the UE is applicable for RLC PDUs associated with a corresponding PSI value, wherein the corresponding PSI value is greater than a PSI threshold value, wherein the first subset of one or more RLC PDUs is autonomously retransmitted based at least in part on a respective PSI value of each RLC PDU of the first subset of one or more RLC PDUs satisfying the PSI threshold value; the at least one controller is configured to cause the processor to: receive an ACK for a second subset of one or more RLC PDUs; and discard the second subset of one or more RLC PDUs based at least in part on the received ACK, wherein the second subset of one or more RLC PDUs comprises of one or more RLC PDUs for which autonomous retransmission has been triggered prior to reception of the ACK; the at least one controller is configured to cause the processor to prioritize the first subset of one or more RLC PDUs for the autonomous retransmission over a second subset of one or more RLC PDUs pending a non-autonomous retransmission and one or more initial RLC PDU transmissions.

Additionally, the processor 1300 may be configured to or operable to support any one or combination of the at least one controller is configured to cause the processor to prioritize allocation of uplink resources for one or more logical channels carrying one or more autonomously retransmitted RLC PDUs over allocation of uplink resources for one or more logical channels carrying non-autonomously retransmitted RLC PDUs; the at least one controller is configured to cause the processor to prioritize a HARQ process associated with one or more autonomously retransmitted RLC PDUs over one or more other HARQ processes; the at least one controller is configured to cause the processor to: communicate information identifying the one or more first RLC PDUs that are autonomously retransmitted; receive an indication of a HARQ ACK for a TB associated with the one or more first RLC PDUs; and prohibit, based at least in part on the HARQ ACK, triggering an additional autonomous retransmission of the one or more first RLC PDUs; the at least one controller is configured to cause the processor to: receive, via inter-layer communication, an indication of a HARQ ACK for the one or more first RLC PDUs; and prohibit, based at least in part on the HARQ ACK, triggering an autonomous retransmission of the one or more first RLC PDUs.

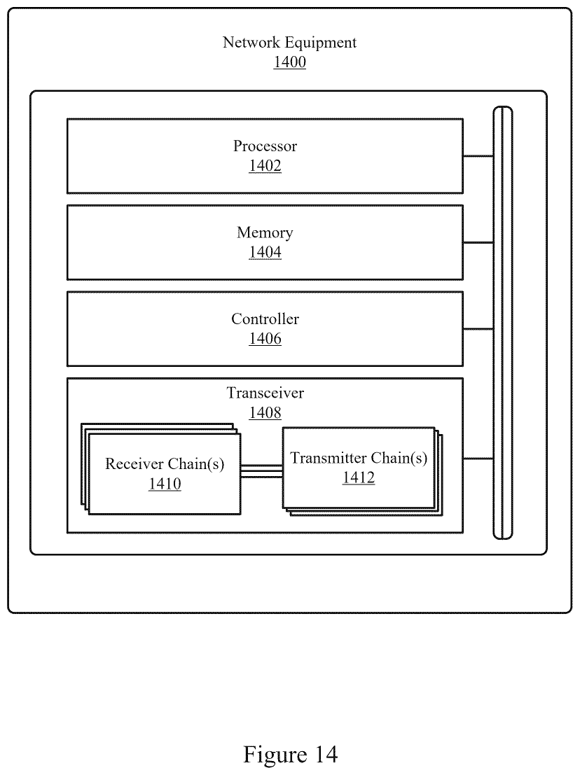

FIG. 14 illustrates an example of a NE 1400 in accordance with aspects of the present disclosure. The NE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the NE 1400 to perform various functions of the present disclosure.

The memory 1404 may include volatile or non-volatile memory. The memory 1404 may store computer-readable, computer-executable code including instructions when executed by the processor 1402 cause the NE 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the NE 1400 to perform one or more of the functions described herein (e.g., executing, by the processor 1402, instructions stored in the memory 1404). For example, the processor 1402 may support wireless communication at the NE 1400 in accordance with examples as disclosed herein. The NE 1400 may be configured to or operable to support a means for transmitting a first configuration associated with a RLC entity of a UE to enable or disable autonomous retransmission for the RLC entity of the UE according to the first configuration and based at least in part on one or more conditions; and transmitting a second configuration associated with the RLC entity of the UE, wherein the second configuration indicates a timer associated with the autonomous retransmission for the RLC entity.

Additionally, the NE 1400 may be configured to or operable to support any one or combination of the first configuration includes a parameter configured to enable or disable autonomous retransmission functionality of the RLC entity; the one or more conditions include one or more of an indication of network congestion or an indication that PSI discarding is enabled; further including transmitting an indication of one or more conditions for performing autonomous retransmission, and wherein the one or more conditions indicate at least one of: autonomous retransmission is constrained to one or more RLC PDUs that are indicated as high-importance RLC PDUs; or autonomous retransmission is constrained to one or more RLC PDUs that have a PSI value greater than a PSI threshold.

Additionally, or alternatively, the NE 1400 may support at least one memory (e.g., the memory 1404) and at least one processor (e.g., the processor 1402) coupled with the at least one memory and configured to cause the NE to transmit a first configuration associated with a RLC entity of a UE to enable or disable autonomous retransmission for the RLC entity of the UE according to the first configuration and based at least in part on one or more conditions; and transmit a second configuration associated with the RLC entity of the UE, wherein the second configuration indicates a timer associated with the autonomous retransmission for the RLC entity.

Additionally, the NE 1400 may be configured to support any one or combination of the first configuration includes a parameter configured to enable or disable autonomous retransmission functionality of the RLC entity; the one or more conditions include one or more of an indication of network congestion or an indication that PSI discarding is enabled; the at least one processor is configured to cause the network equipment to transmit an indication of one or more conditions for performing autonomous retransmission, and wherein the one or more conditions indicate at least one of: autonomous retransmission is constrained to one or more RLC PDUs that are indicated as high-importance RLC PDUs; or autonomous retransmission is constrained to one or more RLC PDUs that have a PSI value greater than a PSI threshold.

The controller 1406 may manage input and output signals for the NE 1400. The controller 1406 may also manage peripherals not integrated into the NE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the NE 1400 may include at least one transceiver 1408. In some other implementations, the NE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas to receive a signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

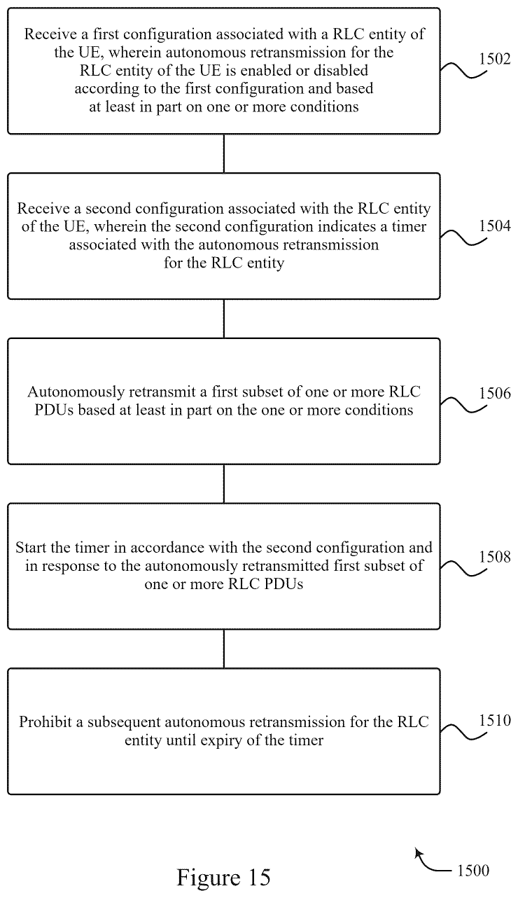

FIG. 15 illustrates a flowchart of a method 1500 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1502, the method may include receiving a first configuration associated with a RLC entity of the UE, wherein autonomous retransmission for the RLC entity of the UE is enabled or disabled according to the first configuration and based at least in part on one or more conditions. The operations of 1502 may be performed in accordance with examples as described herein. In some implementations, aspects of the operations of 1502 may be performed by a UE as described with reference to FIG. 12.

At 1504, the method may include receiving a second configuration associated with the RLC entity of the UE, wherein the second configuration indicates a timer associated with the autonomous retransmission for the RLC entity. The operations of 1504 may be performed in accordance with examples as described herein. In some implementations, aspects of the operations of 1504 may be performed by a UE as described with reference to FIG. 12.

At 1506, the method may include autonomously retransmitting a first subset of one or more RLC PDUs based at least in part on the one or more conditions. The operations of 1506 may be performed in accordance with examples as described herein. In some implementations, aspects of the operations of 1506 may be performed a UE as described with reference to FIG. 12.

At 1508, the method may include starting the timer in accordance with the second configuration and in response to the autonomously retransmitted first subset of one or more RLC PDUs. The operations of 1508 may be performed in accordance with examples as described herein. In some implementations, aspects of the operations of 1508 may be performed a UE as described with reference to FIG. 12.

At 1510, the method may include prohibiting a subsequent autonomous retransmission for the RLC entity until expiry of the timer. The operations of 1510 may be performed in accordance with examples as described herein. In some implementations, aspects of the operations of 1510 may be performed a UE as described with reference to FIG. 12.

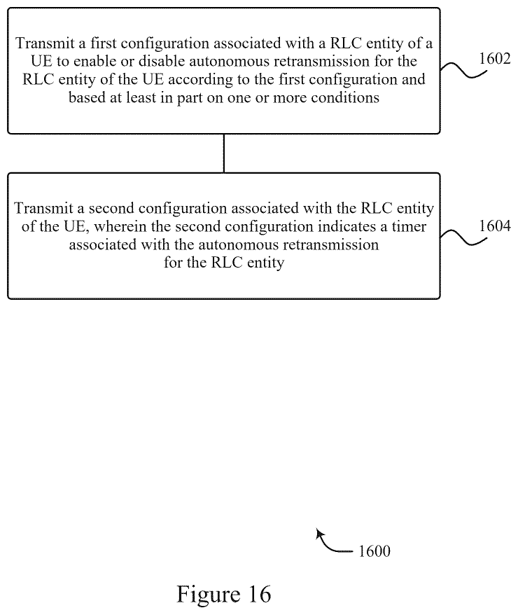

FIG. 16 illustrates a flowchart of a method 1600 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1602, the method may include transmitting a first configuration associated with a RLC entity of a UE) to enable or disable autonomous retransmission for the RLC entity of the UE according to the first configuration and based at least in part on one or more conditions. The operations of 1602 may be performed in accordance with examples as described herein. In some implementations, aspects of the operations of 1602 may be performed by a NE as described with reference to FIG. 14.

At 1604, the method may include transmitting a second configuration associated with the RLC entity of the UE, wherein the second configuration indicates a timer associated with the autonomous retransmission for the RLC entity. The operations of 1604 may be performed in accordance with examples as described herein. In some implementations, aspects of the operations of 1604 may be performed by a NE as described with reference to FIG. 14.

The description herein is provided to enable a person having ordinary skill in the art to make or use the disclosure. Various modifications to the disclosure may be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a first configuration associated with a radio link control (RLC) entity of the UE, wherein autonomous retransmission for the RLC entity of the UE is enabled or disabled according to the first configuration and based at least in part on one or more conditions;
receive a second configuration associated with the RLC entity of the UE, wherein the second configuration indicates a timer associated with the autonomous retransmission for the RLC entity;
autonomously retransmit a first subset of one or more RLC protocol data units (PDUs) based at least in part on the one or more conditions;
start the timer in accordance with the second configuration and in response to the autonomously retransmitted first subset of one or more RLC PDUs; and
prohibit a subsequent autonomous retransmission for the RLC entity until expiry of the timer.

2. The UE of claim 1, wherein:
the second configuration further indicates a threshold number of autonomous retransmissions,
the one or more conditions comprise the threshold number of autonomous retransmissions, and
the first subset of one or more RLC PDUs is autonomously retransmitted based at least in part on the threshold number of autonomous retransmissions.

3. The UE of claim 1, wherein the first configuration comprises a parameter for enabling or disabling the autonomous retransmission for the RLC entity.

4. The UE of claim 3, wherein the first configuration comprising the parameter for enabling or disabling the autonomous retransmission for the RLC entity is received via a radio resource control (RRC) message.

5. The UE of claim 1, wherein the at least one processor is further configured to cause the UE to determine that the autonomous retransmission for the RLC entity of the UE is disabled based at least in part on an absence of a parameter in the received first configuration.

6. The UE of claim 1, wherein the at least one processor is configured to cause the UE to:
identify a network congestion level based at least in part on an indication, or identify that PDU set importance (PSI) discarding is enabled, or both, wherein at least one condition of the one or more conditions comprises the identified network congestion level, or the identified discarding for the RLC entity of the UE being enabled,
wherein the subsequent autonomous retransmission for the RLC entity is prohibited based at least in part on the identified network congestion level, or the identified discarding for the RLC entity of the UE being enabled.

7. The UE of claim 1, wherein the at least one processor is configured to cause the UE to:
identify that the autonomous retransmission for the RLC entity of the UE is applicable for RLC PDUs associated with a priority, wherein at least one condition of the one or more conditions comprises the priority,
wherein the first subset of one or more RLC PDUs is autonomously retransmitted based at least in part on a corresponding priority associated with each RLC PDU of the first subset of one or more RLC PDUs satisfying the priority.

8. The UE of claim 1, wherein the at least one processor is configured to cause the UE to:
identify that the autonomous retransmission for the RLC entity of the UE is applicable for RLC PDUs associated with a corresponding PDU set importance (PSI) value, wherein the corresponding PSI value is greater than a PSI threshold value,
wherein the first subset of one or more RLC PDUs is autonomously retransmitted based at least in part on a respective PSI value of each RLC PDU of the first subset of one or more RLC PDUs satisfying the PSI threshold value.

9. The UE of claim 1, wherein the at least one processor is configured to cause the UE to:
receive an acknowledgement (ACK) for a second subset of one or more RLC PDUs; and
discard the second subset of one or more RLC PDUs based at least in part on the received ACK, wherein the second subset of one or more RLC PDUs comprises of one or more RLC PDUs for which autonomous retransmission has been triggered prior to reception of the ACK.

10. The UE of claim 1, wherein the at least one processor is configured to cause the UE to prioritize the first subset of one or more RLC PDUs for the autonomous retransmission over a second subset of one or more RLC PDUs pending a non-autonomous retransmission and one or more initial RLC PDU transmissions.

11. The UE of claim 1, wherein the at least one processor is configured to cause the UE to prioritize allocation of uplink resources for one or more logical channels carrying one or more autonomously retransmitted RLC PDUs over allocation of uplink resources for one or more logical channels carrying non-autonomously retransmitted RLC PDUs.

12. The UE of claim 1, wherein the at least one processor is configured to cause the UE to prioritize a hybrid automatic repeat request (HARQ) process associated with one or more autonomously retransmitted RLC PDUs over one or more other HARQ processes.

13. The UE of claim 1, wherein the at least one processor is configured to cause the UE to:
communicate information identifying the first subset of one or more RLC PDUs that are autonomously retransmitted;
receive an indication of a hybrid automatic repeat request (HARQ) acknowledgement (ACK) for a transport block (TB) associated with the first subset of one or more RLC PDUs; and
prohibit, based at least in part on the HARQ ACK, triggering an additional autonomous retransmission of the one or more first RLC PDUs.

14. The UE of claim 1, wherein the at least one processor is configured to cause the UE to:
receive, via inter-layer communication, an indication of a hybrid automatic repeat request (HARQ) acknowledgement (ACK) for the one or more first RLC PDUs; and
prohibit, based at least in part on the HARQ ACK, triggering an autonomous retransmission of the one or more first RLC PDUs.

15. A processor for wireless communication, comprising:
at least one controller coupled with at least one memory and configured to cause the processor to:
receive a first configuration associated with a radio link control (RLC) entity of a user equipment (UE), wherein autonomous retransmission for the RLC entity of the UE is enabled or disabled according to the first configuration and based at least in part on one or more conditions;
receive a second configuration associated with the RLC entity of the UE, wherein the second configuration indicates a timer associated with the autonomous retransmission for the RLC entity;
autonomously retransmit a first subset of one or more RLC protocol data units (PDUs) based at least in part on the one or more conditions;
start the timer in accordance with the second configuration and in response to the autonomously retransmitted first subset of one or more RLC PDUs; and
prohibit a subsequent autonomous retransmission for the RLC entity until expiry of the timer.

16. A network equipment for wireless communication, comprising:
at least one memory; and
at least one processor coupled with the at least one memory and configured to cause the network equipment to:
transmit a first configuration associated with a radio link control (RLC) entity of a user equipment (UE) to enable or disable autonomous retransmission for the RLC entity of the UE according to the first configuration and based at least in part on one or more conditions; and
transmit a second configuration associated with the RLC entity of the UE, wherein the second configuration indicates a timer associated with the autonomous retransmission for the RLC entity.

17. The network equipment of claim 16, wherein the first configuration comprises a parameter configured to enable or disable autonomous retransmission functionality of the RLC entity.

18. The network equipment of claim 16, wherein the one or more conditions comprise one or more of an indication of network congestion or an indication that PDU set importance (PSI) discarding is enabled.

19. The network equipment of claim 16, wherein the at least one processor is configured to cause the network equipment to transmit an indication of one or more conditions for performing autonomous retransmission, and wherein the one or more conditions indicate at least one of:
autonomous retransmission is constrained to one or more RLC PDUs that are indicated as high-importance RLC PDUs; or
autonomous retransmission is constrained to one or more RLC PDUs that have a PDU set importance (PSI) value greater than a PSI threshold.

20. A method performed by a user equipment (UE), the method comprising:
receiving a first configuration associated with a radio link control (RLC) entity of the UE, wherein autonomous retransmission for the RLC entity of the UE is enabled or disabled according to the first configuration and based at least in part on one or more conditions;
receiving a second configuration associated with the RLC entity of the UE, wherein the second configuration indicates a timer associated with the autonomous retransmission for the RLC entity;
autonomously retransmitting a first subset of one or more RLC protocol data units (PDUs) based at least in part on the one or more conditions;
starting the timer in accordance with the second configuration and in response to the autonomously retransmitted first subset of one or more RLC PDUs; and
prohibiting a subsequent autonomous retransmission for the RLC entity until expiry of the timer.
